(19) United States
(12) Patent Application Publication
(10) Pub. No.: US 2018/0261224 A1
(43) Pub. Date: Sep. 13, 2018

(54) WIRELESS VOICE-CONTROLLED SYSTEM AND WEARABLE VOICE TRANSMITTING-RECEIVING DEVICE THEREOF

(71) Applicant: Jetvox Acoustic Corp., Taoyuan (TW)

(72) Inventors: To-Teng HUANG, Taoyuan (TW); Shih-Yuan Chen, Taoyuan (TW)

(21) Appl. No.: 15/647,844

(22) Filed: Jul. 12, 2017

(30) Foreign Application Priority Data
Mar. 8, 2017 (TW) 106107565

(51) Int. Cl. G10L 15/26; H04M 1/27; H04N 21/422; G10L 15/08; G10L 15/22

(52) U.S. Cl. CPC G10L 15/265; H04M 1/271; H04N 21/42203; G08C 2201/31; G10L 15/22; H04M 2250/74; G10L 15/083

(57) ABSTRACT

A wireless voice-controlled system includes a wearable voice transmitting-receiving device including a voice-receiving unit, a first wireless transmitting-receiving unit, and a first processor and a controlled electrical device including a second wireless transmitting-receiving unit and a second processor. The voice-receiving unit receives a voice instruction and converts the voice instruction into an audio signal. The first wireless transmitting-receiving unit receives the audio signal, wirelessly transmits the audio signal out, and receives a text signal corresponding to the audio signal. The first processor receives the text signal, generates a control signal according to the text signal, and wirelessly transmits the control signal to the first wireless transmitting-receiving unit. The second wireless transmitting-receiving unit is in wireless communication with the first wireless transmitting-receiving unit and wirelessly receives the control signal. The second processor receives the control signal and performs an operation according to the control signal.

### CROSS-REFERENCE TO RELATED APPLICATION

This non-provisional application claims priority under 35 U.S.C. § 119(a) to Patent Application No. 106107565 filed in Taiwan, R.O.C. on Mar. 8, 2017, the entire contents of which are hereby incorporated by reference.

### BACKGROUND

### Technical Field

The instant disclosure relates to voice control technologies, in particular, to a wireless voice-controlled system and a wearable voice transmitting-receiving device thereof.

### Related Art

With developments of wireless networks and smart phones, it becomes a trend for Internet of Things (IoT) that measured data, like electricity or heartbeat, are recorded and wirelessly transmitted to the mobile phone or tablet computer, so that users can check or analyze the measured data. Moreover, along with the developments of smart home systems, home appliances may be remotely operated through mobile phones, thereby improving the convenience in daily life.

Conventional smart home systems take mobile phones or tablet computers as important interfaces for connecting to smart hosts of the systems, so that the smart home system can transmit the control signals to different home appliances. However, in this case, the user has to take the mobile phone or the tablet computer everywhere and every time for operating the home appliances, such operation situations are not friendly to users who are busy user or to users with disabilities. Additionally, in the conventional, the control signals have to be computed by the mobile device as well as the smart hosts. Nowadays, mobile devices and smart hosts are installed with complicated operating system, resulting in slower speed in transmission and computation of the control signals. Consequently, the conventional smart home systems are insufficient to satisfy user requirements.

### SUMMARY

In view of these problems, a wireless voice-controlled system is provided. In one embodiment, the wireless voice-controlled system comprises a wearable voice transmitting-receiving device and a controlled electrical device. The wearable voice transmitting-receiving device comprises a voice receiving unit, a first wireless transmitting-receiving unit, and a first processor. The controlled electrical device comprises a second wireless transmitting-receiving unit and a second processor. The voice receiving unit receives a voice instruction and converts the voice instruction into an audio signal. The first wireless transmitting-receiving unit is electrically connected to the voice receiving unit and receives the audio signal. The first wireless transmitting-receiving unit wirelessly transmits the audio signal out and wirelessly receives a text signal. The text signal comprises a text message for corresponding to the audio signal. The first processor is electrically connected to the first wireless transmitting-receiving unit and receives the text signal. The first processor generates a control signal according to the text signal and transmits the control signal back to the first wireless transmitting unit. The control signal comprises at least one control instruction. The first wireless transmitting-receiving unit wirelessly transmits the control signal. The second wireless transmitting-receiving unit is in wireless communication with the first wireless transmitting-receiving unit and wirelessly receives the control signal. The second processor is electrically connected to the second wireless transmitting-receiving unit and receives the control signal. The second processor executes the at least one control instruction of the control signal to perform a corresponding operation.

In one embodiment, the audio signal is uncompressed audio code or compressed audio code.

In one embodiment, the wireless voice-controlled system further comprises a cloud server. The cloud server is in wireless communication with the first wireless transmitting-receiving unit and wirelessly receives the audio signal. The cloud server converts the audio signal into the text signal and wirelessly transmitting the text signal back to the first wireless transmitting-receiving unit. Moreover, the first wireless transmitting-receiving unit comprises a short-distance wireless transceiver. The short-distance wireless transceiver is in wireless communication with the second wireless transmitting-receiving unit. In one embodiment, the wireless voice-controlled system further comprises a wireless router, and the short-distance wireless transceiver is in communication with the cloud server via the wireless router. In another embodiment, the first wireless transmitting-receiving unit further comprises a short-distance wireless transceiver and a long-distance wireless transceiver, the long-distance wireless transceiver is in communication with the cloud server, and the short-distance wireless transceiver is in wireless communication with the second wireless transmitting-receiving unit.

In one embodiment, the wireless voice-controlled system further comprises a voice translator. The voice translator is in wireless communication with the first wireless transmitting-receiving unit and wirelessly receives the audio signal. The voice translator converts the audio signal into the text signal and transmits the text signal back to the first wireless transmitting-receiving unit. Furthermore, the first wireless transmitting-receiving unit comprises a short-distance wireless transceiver, and the short-distance wireless transceiver is in wireless communication with the voice translator and the second wireless transmitting-receiving unit, respectively.

In one embodiment, the wearable voice transmitting-receiving device further comprises a first memory module. The first memory module stores an instruction correspondence table. The first processor checks the instruction correspondence table to select the at least one control instruction corresponding to the text signal. Moreover, the controlled electrical device further comprises identification information, and the first memory module further stores an identification correspondence table, the first processor further checks the identification correspondence table to select an identification message corresponding to the text signal, the control signal further comprises the identification message, and the second processor executes the at least one control instruction when the second processor checks the identification information matches with the identification message. Furthermore, the controlled electrical device further comprises a plurality of relay switches, each of the relay switches further comprises a serial number, the first memory module further stores a serial-number correspondence table, the first processor further checks the serial-number correspondence table to select a serial-number identification message corresponding to the text signal, the control signal further comprises the serial-number identification message, and the second processor executes the at least one control instruction when the second processor checks the serial number matches with the serial-number identification message.

In one embodiment, the second processor further generates a feedback signal in response to the control signal and wirelessly transmits the feedback signal to the first wireless transmitting-receiving unit via the second wireless transmitting-receiving unit. The feedback signal may be a feedback audio signal, a response instruction, or a combination thereof. The wearable voice transmitting-receiving device further comprises a response unit to perform a response operation for the feedback signal.

In one embodiment, the wearable voice transmitting-receiving device is a wearable headset microphone device, a wearable microphone, or a wearable wireless microphone, the controlled electrical device is a smart receptacle, a smart audio equipment, a smart air-conditioner, or a smart extension phone. The wearable headset microphone device may have the functions of earphone and microphone.

In one embodiment, a wearable voice transmitting-receiving device is provided. The wearable voice transmitting-receiving device comprises a voice receiving unit, a wireless transmitting-receiving unit, and a processor. The voice receiving unit receives a voice instruction and converts the voice instruction into an audio signal. The wireless transmitting-receiving unit is electrically connected to the voice receiving unit and receives the audio signal. The wireless transmitting-receiving unit wirelessly transmits the audio signal out and wirelessly receives a text signal. The text signal comprises a text message corresponding to the audio signal. The processor is electrically connected to the wireless transmitting-receiving unit and receives the text signal. The processor generates a control signal according to the text signal and transmits the control signal back to the wireless transmitting-receiving unit. The control signal comprises at least one control instruction. The wireless transmitting-receiving unit wirelessly transmits the control signal out.

In one embodiment, the audio signal is uncompressed audio code or compressed audio code.

In one embodiment, the wearable voice transmitting-receiving device further comprises a memory module storing an instruction correspondence table, the processor checks the instruction correspondence table to select the at least one control instruction corresponding to the text signal. Moreover, the memory module further stores an identification correspondence table, the processor further checks the identification correspondence table to select an identification message corresponding to the text signal, the control signal further comprises the identification message.

As above, the wireless voice-controlled system uses the wearable voice transmitting-receiving device to control the controlled electrical device in voice directly. Therefore, intermediate devices are not required for the system, greatly reducing the cost of the system and thus making the product more competitive in the industry. In addition, because the calculation time and the transmission time of the intermediate device are saved, the overall calculation time and the overall transmission time become shorter, allowing the wireless voice-controlled system to perform instant control. Moreover, instead of taking out the mobile phone and using it, the user can just wear the wearable voice transmitting-receiving device to control the controlled electrical device, thereby improving the convenience in operation.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view of a wireless voice-controlled system of a first embodiment of the instant disclosure;

FIG. 2 illustrates a block diagram of one embodiment of the wireless voice-controlled system shown in FIG. 1;

FIG. 3 illustrates a block diagram of one embodiment of wireless transmission of the wireless voice-controlled system shown in FIG. 2;

FIG. 4 illustrates a block diagram of another embodiment of wireless transmission of the wireless voice-controlled system shown in FIG. 2;

FIG. 5 illustrates a block diagram of another embodiment of the wireless voice-controlled system shown in FIG. 1;

FIG. 6 illustrates a block diagram of one embodiment of wireless transmission of the wireless voice-controlled system shown in FIG. 5;

FIG. 7 illustrates a schematic view of a wireless voice-controlled system of a second embodiment of the instant disclosure;

FIG. 8 illustrates a schematic view of a wireless voice-controlled system of a third embodiment of the instant disclosure;

FIG. 9 illustrates a schematic view of a wireless voice-controlled system of a fourth embodiment of the instant disclosure; and

FIG. 10 illustrates a flowchart of an operating method for the wireless voice-controlled system.

### DETAILED DESCRIPTION

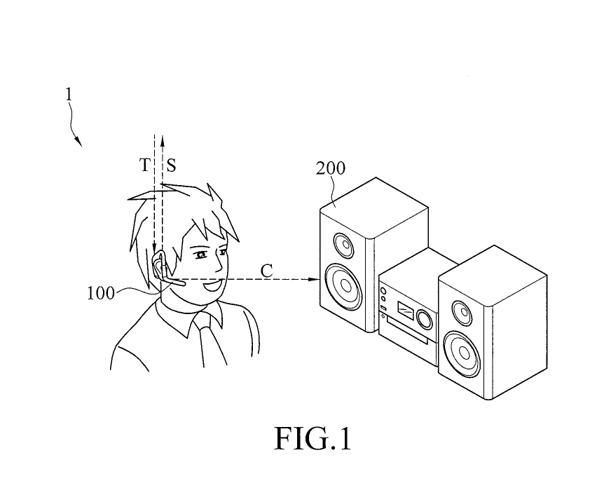

FIG. 1 illustrates a schematic view of a wireless voice-controlled system of a first embodiment of the instant disclosure. As shown in FIG. 1, the wireless voice-controlled system 1 comprises a wearable voice transmitting-receiving device 100 and a controlled electrical device 200. In this embodiment, the wearable voice transmitting-receiving device 100 may be, but not limited to, a wearable headset microphone device. The wearable headset microphone device may have the functions of microphone and earpohone. In another embodiment, the wearable voice transmitting-receiving device 100 may be a wearable microphone or a wearable wireless microphone. The controlled electrical device 200 may be, but not limited to, a smart audio equipment, a smart receptacle, a smart lamp, a smart air conditioner, or a smart refrigerator.

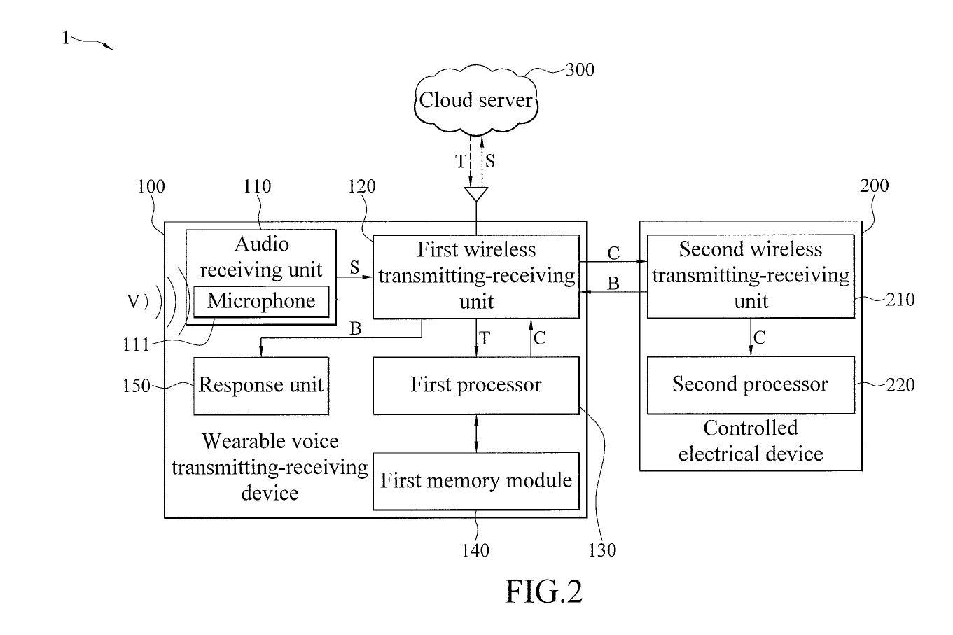

FIG. 2 illustrates a block diagram of one embodiment of the wireless voice-controlled system shown in FIG. 1. As shown in FIGS. 1 and 2, the wearable voice transmitting-receiving device 100 comprises a voice receiving unit 110, a first wireless transmitting-receiving unit 120, and a first processor 130. The voice receiving unit 110 receives a voice instruction V and converts the voice instruction V into an audio signal S. The conversion between the voice instruction V and the audio signal S is a transformation between voice and electrical signals, and the conversion manner for generating the audio signal S as well as the format of the converted audio signal S are not limited. The first wireless transmitting-receiving unit 120 is electorally connected to the voice receiving unit 110 and receives the audio signal S. The first wireless transmitting-receiving unit 120 further wirelessly transmits the audio signal S out and wirelessly receives a text signal T. The first processor 130 is electrically connected to the first wireless transmitting-receiving unit 120 and receives the text signal T. The first processor 130 generates a control signal C according to the text signal T and transmits the control signal C back to the first wireless transmitting-receiving unit 120. The control signal C comprises at least one control instruction. The first wireless transmitting-receiving unit 120 wirelessly transmits the control signal C out.

The controlled electrical device 200 comprises a second wireless transmitting-receiving unit 210 and a second processor 220. The second wireless transmitting-receiving unit 210 is in wireless communication with the first wireless transmitting-receiving unit 120 and wirelessly receives the control signal C. The second processor 220 is electrically connected to the second wireless transmitting-receiving unit 210 and receives the control signal C. The second processor 220 executes the at least one control instruction of the control signal C to perform a corresponding operation.

Here, the voice instruction V is uttered by a user, and the voice instruction V may be a single word or a phrase. It is understood that, the voice instruction V may not be uttered by the user alone; that is, the voice instruction V may be a part of a sentence uttered by the user. The voice receiving unit 110 may comprise a microphone 111 to receive the voice instruction V and to convert the voice instruction V in analog format into the audio signal S in digital format. The text signal T comprises a text message corresponding to the audio signal S. For example, the text signal T may be a word-by-word code corresponding to the audio signal S.

As shown in FIG. 2, the wireless voice-controlled system 1 may comprise a cloud server 300. The cloud server 300 is in wireless communication with the first wireless transmitting-receiving unit 120 and wirelessly receives the audio signal S. The cloud server 300 converts the audio signal S into the text signal T and wirelessly transmits the text signal T back to the first wireless transmitting-receiving unit 120.

In practice, the format of the audio signal S may be lossless compressed audio code (with filename extension of “.flac”), so that the audio signal S can have smaller file size for rapid transmission, as compared with an audio signal S encoded with normal uncompressed audio code. Furthermore, the audio signal S encoded with lossless compressed audio code is not distorted when the audio signal S is sampled. Therefore, the voice of the file is clear, thereby facilitating in recognition by the cloud server 300 and in converting into the text signal T. In other words, after the wearable voice transmitting-receiving device 100 is in wireless communication with the cloud server 300, the voice receiving unit 110 may, but not limited to, receive the voice instruction V in analog format, convert the voice instruction V in analog format into an audio signal S in digital uncompressed audio code format (with filename extension of “.wav”), and further convert the audio signal S in digital uncompressed audio code format into an audio signal S in digital lossless compressed audio code format (with filename extension of “.flac”), and the audio signal S in digital lossless compressed audio code format is thus transmitted by the first wireless transmitting-receiving unit 120. In one embodiment, the voice receiving unit 110 may only receive the voice instruction V in analog format and convert the voice instruction V in analog format into an audio signal S in digital uncompressed audio code format (with filename extension of “.wav”), and the audio signal S in digital uncompressed audio code format is transmitted by the first wireless transmitting-receiving unit 120. Next, the cloud server 300 converts the audio signal S in digital uncompressed audio code format (with filename extension of “.wav”) into an audio signal S in digital lossless compressed audio code format (with filename extension of “.flac”).

However, it is understood that, the format of the audio signal S is not limited to the aforementioned embodiments, and the format of the audio signal S may be encoded with uncompressed audio code or compressed audio code. Compressed audio code may be lossless compressed audio code, e.g., with filename extension of “.flac” and “.ape”, or may be distorted compressed audio code, e.g., with filename extension of “.mp3”, “.wma”, and “.ogg”.

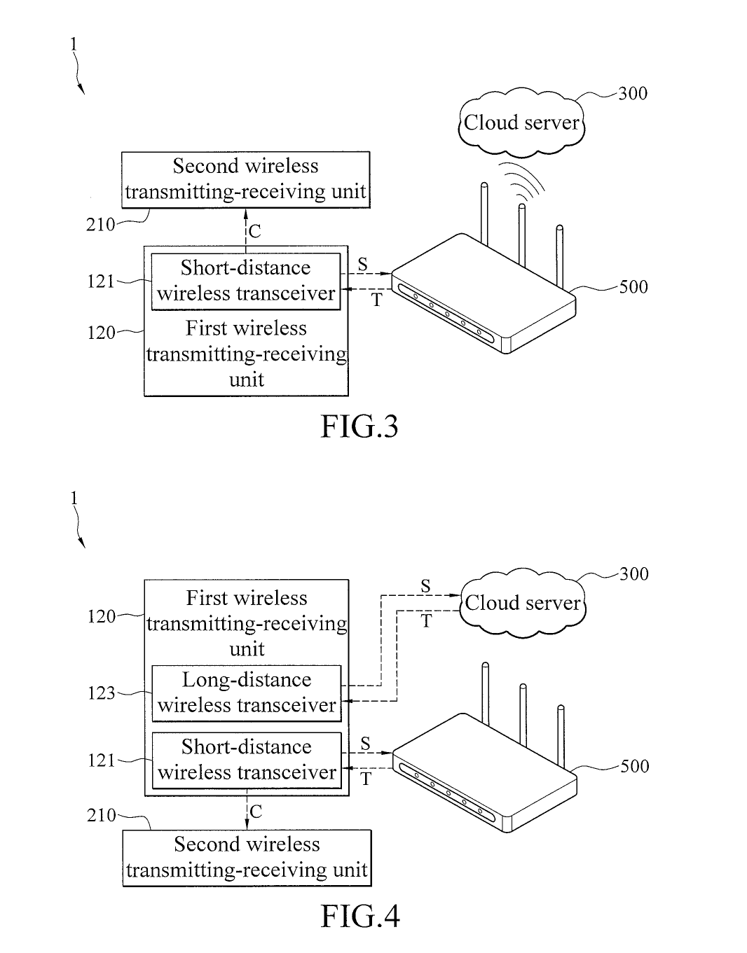

FIG. 3 illustrates a block diagram of one embodiment of wireless transmission of the wireless voice-controlled system shown in FIG. 2. As shown in FIG. 3, the first wireless transmitting-receiving unit 120 comprises a short-distance wireless transceiver 121. The short-distance wireless transceiver 121 is in wireless communication with the second wireless transmitting-receiving unit 210. The short-distance wireless transceiver 121 and the second wireless transmitting-receiving unit 210 may be wireless transceivers with Wi-Fi, Zigbee, Bluetooth, or near-field communication interfaces. As shown in FIG. 3, the wearable voice transmitting-receiving device 100 and the controlled electrical device 200 are in a Wi-Fi environment created by a wireless router 500, and the short-distance wireless transceiver 121 is in wireless communication with the second wireless transmitting-receiving unit 210. Furthermore, the short-distance wireless transceiver 121 is connected to mobile data internet via the wireless router 500 so as to build a connection with the cloud server 300. It is understood that, the wireless transmission manner of the system shown in FIG. 3 is for illustration purpose, but not the limitation to the instant disclosure.

FIG. 4 illustrates a block diagram of another embodiment of wireless transmission of the wireless voice-controlled system shown in FIG. 2. As shown in FIG. 4, in this embodiment, the first wireless transmitting-receiving unit 120 further comprises a long-distance wireless transceiver 123, and the long-distance wireless transceiver 123 is in communication with the cloud server 300. The long-distance wireless transceiver 123 may be a wireless transceiver with 3G/4G interface or other mobile data communication protocol standards. In other words, the wearable voice transmitting-receiving device 100 may be regarded as a mobile data device and in communication with mobile data internet. It is understood that, the wireless transmission manner of the system shown in FIG. 4 is for illustration purpose, but not the limitation to the instant disclosure. The way for wireless transmission between the wearable voice transmitting-receiving device 100 and the cloud server 300 may be altered according to the signal intensity.

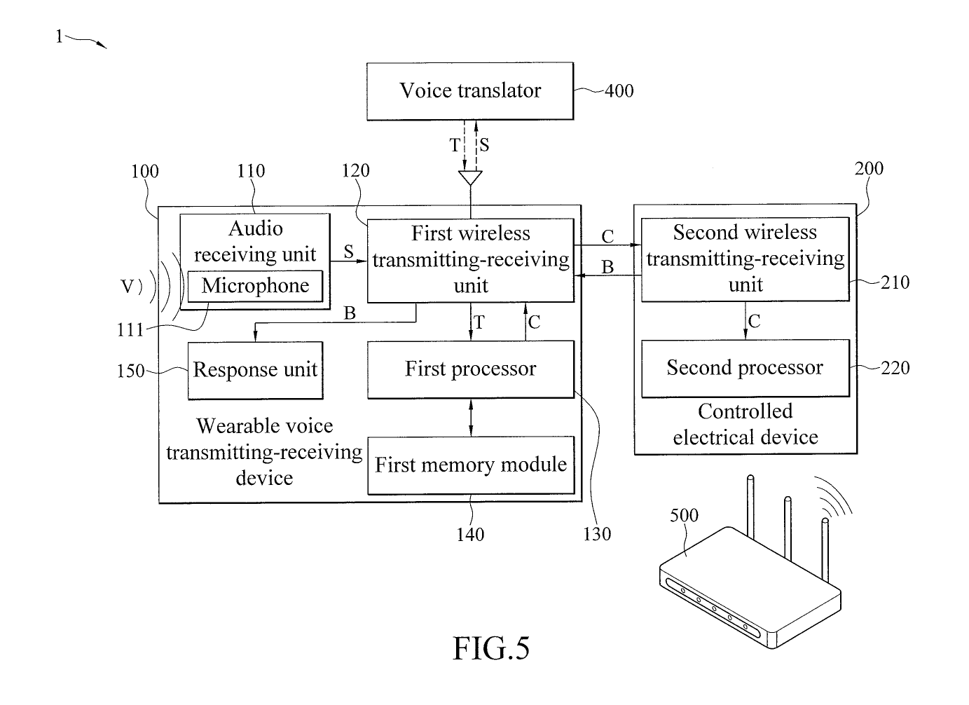

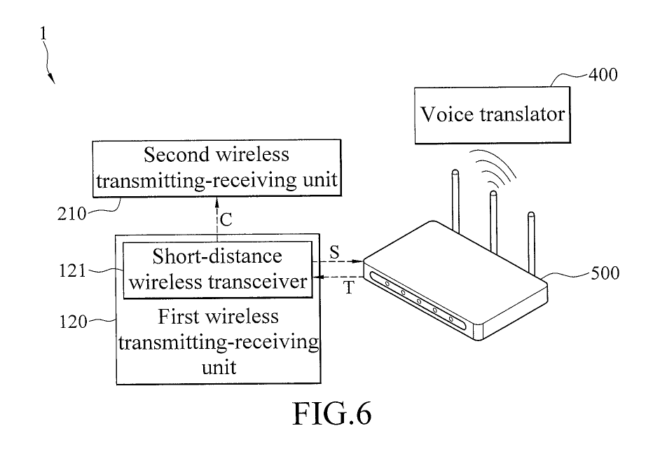

FIG. 5 illustrates a block diagram of another embodiment of the wireless voice-controlled system shown in FIG. 1. As shown in FIG. 5, the wireless voice-controlled system 1 further comprises a voice translator 400. The voice translator 400 is in wireless communication with the first wireless transmitting-receiving unit 120 and wirelessly receives the audio signal S. The voice translator 400 converts the audio signal S into the text signal T and wirelessly transmits the text signal T back to the first wireless transmitting-receiving unit 120. In other words, the wireless voice-controlled system 1 can convert the audio signal S into the text signal T not only via the cloud server 300 at a remote end but also via the voice translator 400 in the same wireless environment. FIG. 6 illustrates a block diagram of one embodiment of wireless transmission of the wireless voice-controlled system shown in FIG. 5. As shown in FIG. 6, the first wireless transmitting-receiving unit 120 comprises a short-distance wireless transceiver 121. The short-distance transceiver 121 is in wireless communication with the voice translator 400 and the second wireless transmitting-receiving unit 210, respectively. In other words, the wearable voice transmitting-receiving device 100 can be in wireless communication with the voice translator 400 and the controlled electrical device 200 via short-distance wireless environments, such as, Wi-Fi, Zigbee, Bluetooth, near-field communication interfaces.

Please refer to FIGS. 1 and 2. In this embodiment, the controlled electrical device 200 is a smart audio equipment as an example. The wearable voice transmitting-receiving device 100 further comprises a first memory module 140. The first memory module 140 stores an instruction correspondence table. The first processor 130 checks the instruction correspondence table to select at least one control instruction corresponding to the text signal T. For example, the voice instruction V uttered by the user may be “turn on”, “turn off”, “play”, “stop”, “pause”, “previous track”, “next track”, “volume up”, “volume down”, etc. After the wearable voice transmitting-receiving device 100 receives the corresponding text signal T, the first processor 130 checks the instruction correspondence table stored in the first memory module 140 and select a control signal C, and the control signal C is transmitted to the second wireless transmitting-receiving unit 210 via the first wireless transmitting-receiving unit 120. After the second processor 220 receives the control signal, the second processor 220 executes the control instruction of the control signal to perform a corresponding operation, for example, the operation may be, but not limited to, turn on the audio equipment, turn off the audio equipment, play music, stop music, pause music. It is understood that, the first memory module 140 may store different instructions for different smart home appliances.

The instruction correspondence table may be set when the wearable voice transmitting-receiving device 100 matches with the controlled electrical device 200 or may be set and stored in the cloud server 300 via other devices (such as a personal computer, a tablet computer, or a smart phone) in advance and then be downloaded from the cloud server 300 when the wearable voice transmitting-receiving device 100 matches with the controlled electrical device 200.

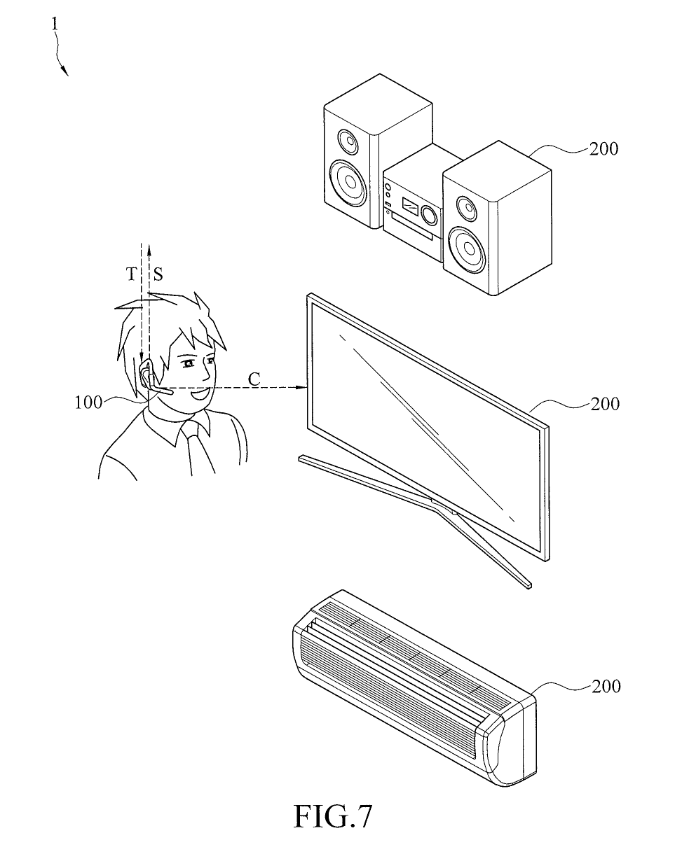

FIG. 7 illustrates a schematic view of a wireless voice-controlled system of a second embodiment of the instant disclosure. As shown in FIG. 7, the wireless voice-controlled system 1 comprises a wearable voice transmitting-receiving device 100 and a plurality of controlled electrical devices 200. In order to allow the wearable voice transmitting-receiving device 100 to control the controlled electrical devices 200 in the same environment, each of the controlled electrical devices 200 has identification information, and the identification information may be stored in the built-in memory of the second processor 220 of the controlled electrical device 200. As mentioned above, the wearable voice transmitting-receiving device 100 further comprises a first memory module 140. In this embodiment, the first memory module 140 stores not only the instruction correspondence table but also an identification instruction table. After the first processor 130 receives the text signal T, the first processor 130 further checks the identification correspondence table to select an identification message corresponding to the text signal T. In this embodiment, the control signal C not only comprises the control instruction but also comprises an identification message. The second processor 220 executes the control instruction when the second processor 220 checks the identification information matches with the identification message. For example, in the same wireless environment, each of the controlled electrical devices 200 corresponds to a corresponding IP address, and in the identification correspondence table, IP1 may be stored to correspond to a speaker, IP2 may be stored to correspond to a television, IP3 may be stored to correspond to an air-conditioner, and so forth. In this case, the voice instruction V from the user may be “television, turn on”. After the first processor 130 receives the text signal T, the first processor 130 further checks the identification correspondence table and the instruction correspondence table to select the control signal C, and the control signal C is then transmitted to the second wireless transmitting-receiving unit 210 via the first wireless transmitting-receiving unit 120. After the second processor 220 receives the control signal C, the second processor 220 identifies “television” in the control signal C as the identification message for IP2 and identifies “turn on” in the control signal C as the control instruction. Therefore, an operation for turning on a television can be executed by the system.

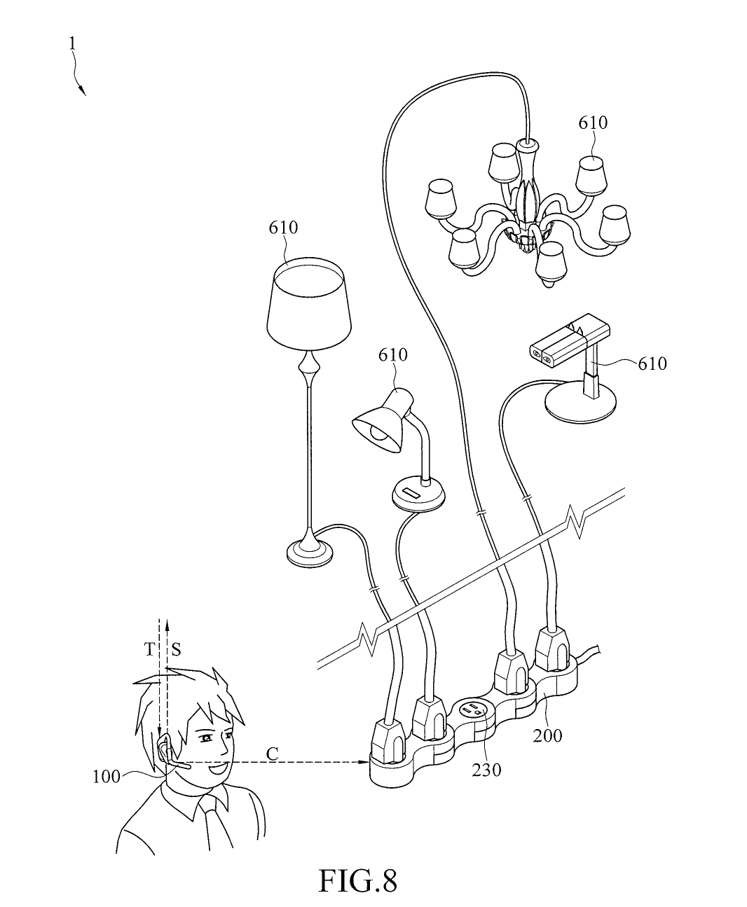

FIG. 8 illustrates a schematic view of a wireless voice-controlled system of a third embodiment of the instant disclosure. As shown in FIG. 8, the wireless voice-controlled system 1 comprises a wearable voice transmitting-receiving device 100 and a controlled electrical device 200. In this embodiment, the controlled electrical device 200 is a smart receptacle and has several relay switches 230. Each of the relay switches 230 further comprises a serial number. The first memory module 140 further stores a serial-number correspondence table. The first processor 140 further checks the serial-number correspondence table to select a serial-number identification message corresponding to the text signal T. The control signal C further comprises a serial-number identification message. The second processor 220 executes the at least one control instruction when the second processor 220 checks the serial number matches with the serial-number identification message. For example, a first relay switch 230, a second relay switch 230, a third relay switch 230, and a fourth relay switch 230 of the smart receptacle having identification information “receptacle 1” are respectively connected to different lamps 610, and the serial numbers for the first relay switch 230, the second relay switch 230, the third relay switch 230, and the fourth relay switch 230 are respectively “first lamp”, “second lamp”, “third lamp”, and “fourth lamp”. In this case, the voice instruction V from the user may be “receptacle 1, first lamp, turn on”. After the first processor 130 receives the text signal T, the first processor 130 checks the identification correspondence table, the instruction correspondence table, and the serial-number correspondence table to select a corresponding control signal C. Then, the control signal C is transmitted to the second wireless transmitting-receiving unit 210 via the first wireless transmitting-receiving unit 120. After the second processor 220 receives the control signal C, the second processor 220 identifies “receptacle” in the control signal C as the identification message, “first lamp” in the control signal C as the serial number, and “turn on” in the control signal C as the control instruction. Therefore, an operation for turning on the first relay switch can be executed by the system.

The identification correspondence table as well as the serial-number correspondence table may be set when the wearable voice transmitting-receiving device 100 matches with the controlled electrical device 200 or may be set and stored in the cloud server 300 via other devices (such as a personal computer, a tablet computer, or a smart phone) in advance and then be downloaded from the cloud server 300 when the wearable voice transmitting-receiving device 100 matches with the controlled electrical device 200.

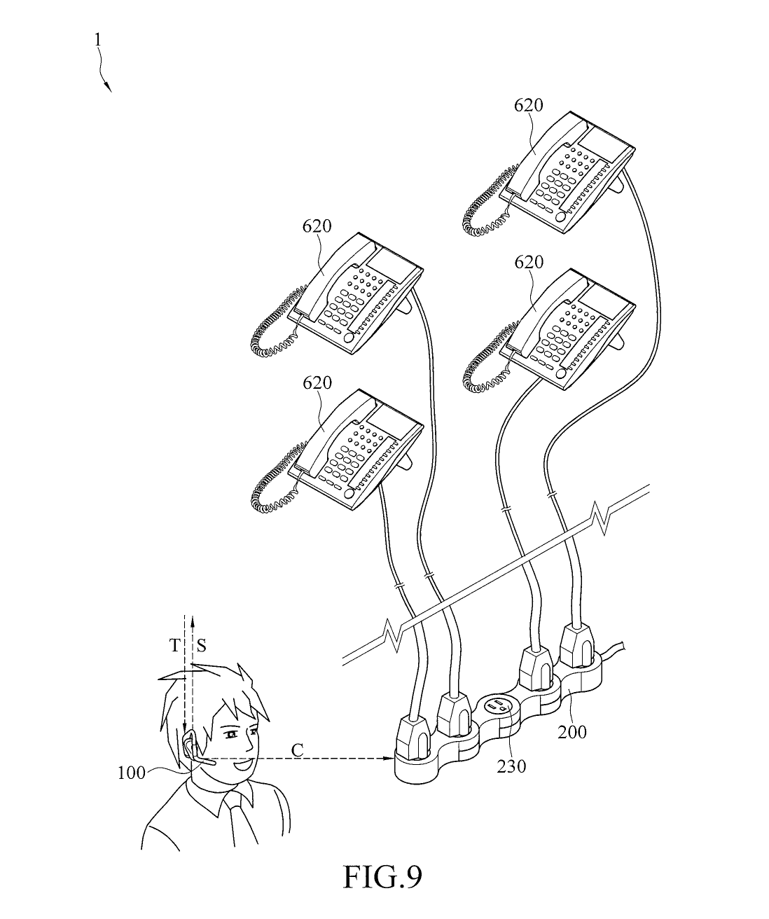

FIG. 9 illustrates a schematic view of a wireless voice-controlled system of a fourth embodiment of the instant disclosure. As shown in FIG. 9, the fourth embodiment is a different implementation from the third embodiment. In the fourth embodiment, the first relay switch 230, the second relay switch 230, the third relay switch 230, and the fourth relay switch 230 of a smart receptacle having identification information “receptacle 1” are respectively connected to different phones 620, and the serial numbers for the first relay switch 230, the second relay switch 230, the third relay switch 230, and the fourth relay switch 230 are respectively “extension phone 101”, “extension phone 102”, “extension phone 103”, and “extension phone 104”. In this case, the voice instruction V from the user may be “receptacle 1, extension phone 101, turn on”. After the first processor 130 receives the text signal T, the first processor 130 checks the identification correspondence table, the instruction correspondence table, and the serial-number correspondence table to select a corresponding control signal C. Then, the control signal C is transmitted to the second wireless transmitting-receiving unit 210 via the first wireless transmitting-receiving unit 120. After the second processor 220 receives the control signal C, the second processor 220 identifies “receptacle” in the control signal C as the identification message, “extension phone 101” in the control signal C as the serial number, and “turn on” in the control signal C as the control instruction. Therefore, an operation for turning on the first relay switch can be executed by the system.

The system shown in FIG. 1 and FIGS. 7 to 9 are embodiments for illustration purposes, but not limitations to the instant disclosure. For example, in the case that the controlled electrical device 200 is a single smart receptacle and the wearable voice transmitting-receiving device 100 does not connect to other controlled electrical devices 200, the identification information and the identification correspondence table may be omitted, and the first processor 130 may only have the instruction correspondence table and the serial-number correspondence table to select the control signal C.

Furthermore, as shown in FIGS. 2 and 5, the second processor 220 further generates a feedback signal B in response to the control signal C, and the second processor 220 wirelessly transmits the feedback signal B to the first wireless transmitting-receiving unit 120 via the second wireless transmitting-receiving unit 210. The feedback signal B may be a feedback audio signal, a response instruction, or a combination thereof. The wearable voice transmitting-receiving device 100 further comprises a response unit 150. The response unit 150 is capable of performing a response operation for the feedback signal B. For example, the response unit 150 may be a play device, an indicating lamp, or an oscillator, etc. In the case that the response unit 150 is a play device, when the second processor 220 finishes the operation corresponding to the control signal C, the second processor 220 may generate a feedback audio signal indicating that the operation is finished, the feedback audio signal is then transmitted to the first wireless transmitting-receiving unit 120 via the second wireless transmitting-receiving unit 210, and the feedback audio signal is played by the response unit 150. In another embodiment, the response unit 150 may comprise several indicating lamps. After the operation corresponding to the control signal C is finished, the second processor 220 generates a response instruction for enabling the response unit 150 to generate twinkling green lights or to generate oscillation corresponding to the operation. Moreover, when the wearable voice transmitting-receiving device 100 and the controlled electrical device 200 are matched with each other, the second processor 220 may generate the response signal B.

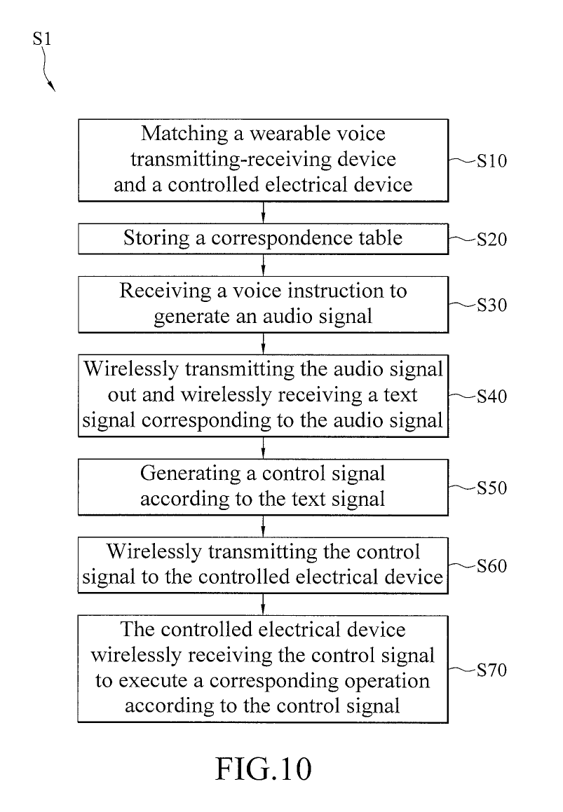

FIG. 10 illustrates a flowchart of an operating method for the wireless voice-controlled system. As shown in FIG. 10, the operating method S1 for the wireless voice-controlled system comprises steps S10 to S70. Please refer to FIGS. 1 to 9, in the step S10, the wearable voice transmitting-receiving device 100 is matched with the controlled electrical device 200. In this embodiment, the user may match the wearable voice transmitting-receiving device 100 and the controlled electrical device 200 which are already connected to the wireless environment with each other via a computer, a mobile phone, a tablet computer, etc. Then, a correspondence table is shown on the computer, the mobile phone, or the tablet computer. The correspondence table at least comprises the instruction correspondence table and may further comprise the identification correspondence table and/or the serial-number correspondence table. In the step S20, the computer, the mobile phone, or the tablet computer transmits the correspondence table to the first memory module 140 of the wearable voice transmitting-receiving device 100. The wearable voice transmitting-receiving device 100 and the controlled electrical device 200 may act as a controlling end and a controlled end in the wireless environment, respectively, and the computer, the mobile phone, or the tablet computer are not needed for subsequent operations.

In the step S30, the wearable voice transmitting-receiving device 100 may be implemented by a wearable wireless headset microphone. The microphone may be a micro-electromechanical systems (MEMS) microphone or a bone conduction microphone for receiving the voice in a clear manner. The voice receiving unit 110 receives the voice instruction V from the user, for example, “speaker, turn on”, the voice receiving unit 110 converts the voice instruction V in analog format into the audio signal S in digital format. In the step S40, the audio signal S is wirelessly transmitted by the first wireless transmitting-receiving unit 120. For example, the audio signal S may be transmitted to the cloud server 300 or the voice translator 400, and the first wireless transmitting-receiving unit 120 wirelessly receives the text signal T corresponding to the audio signal S from the cloud server 300 or from the voice translator 400.

In the step S50, the first processor 130 further checks the instruction correspondence table, the identification correspondence table, and/or the serial-number correspondence table according to the text signal T to generate the control signal C corresponding to the controlled electrical device 200. The control signal C comprises the control instruction and may further comprise the identification message and the serial-number identification message. In the step S60, the first wireless transmitting-receiving unit 120 transmits the control signal C to the second wireless transmitting-receiving unit 210 of the controlled electrical device 200. In the step S70, the second processor 220 executes a corresponding operation according to the control instruction of the control signal C. Furthermore, the second processor 220 further checks if the identification message matches with the identification information and if the serial-number identification message matches with the serial number, if match, the second processor 220 executes the operation corresponding to the control instruction.

As above, the wireless voice-controlled system uses the wearable voice transmitting-receiving device to control the controlled electrical device in voice directly. Therefore, intermediate devices are not required for the system, greatly reducing the cost of the system and thus making the product more competitive in the industry. In addition, because the calculation time and the transmission time of the intermediate device are saved, the overall calculation time and the overall transmission time become shorter, allowing instant control. Moreover, instead of taking out the mobile phone and using it, the user can just wear the wearable voice transmitting-receiving device to control the controlled electrical device, thereby improving the convenience in operation.

What is claimed is:

1. A wireless voice-controlled system comprising a wearable voice transmitting-receiving device and a controlled electrical device;
wherein the wearable voice transmitting-receiving device comprises:
a voice receiving unit receiving a voice instruction and converting the voice instruction into an audio signal;
a first wireless transmitting-receiving unit electrically connected to the voice receiving unit and receiving the audio signal, the first wireless transmitting-receiving unit wirelessly transmitting the audio signal out and wirelessly receiving a text signal, wherein the text signal comprises a text message corresponding to the audio signal; and
a first processor electrically connected to the first wireless transmitting-receiving unit and receiving the text signal, the first processor generating a control signal according to the text signal and transmitting the control signal back to the first wireless transmitting-receiving unit, the control signal comprising at least one control instruction, the first wireless transmitting-receiving unit wirelessly transmitting the control signal out;
wherein the controlled electrical device comprises:
a second wireless transmitting-receiving unit being in wireless communication with the first wireless transmitting-receiving unit and wirelessly receiving the control signal; and
a second processor electrically connected to the second wireless transmitting-receiving unit and receiving the control signal, the second processor executing the at least one control instruction of the control signal to perform a corresponding operation.

2. The wireless voice-controlled system according to claim 1, wherein the audio signal is uncompressed audio code or compressed audio code.

3. The wireless voice-controlled system according to claim 1, further comprising a cloud server being in wireless communication with the first wireless transmitting-receiving unit and wirelessly receiving the audio signal, the cloud server converting the audio signal into the text signal and wirelessly transmitting the text signal back to the first wireless transmitting-receiving unit.

4. The wireless voice-controlled system according to claim 3, wherein the first wireless transmitting-receiving unit comprises a short-distance wireless transceiver, the short-distance wireless transceiver is in wireless communication with the second wireless transmitting-receiving unit.

5. The wireless voice-controlled system according to claim 4, further comprising a wireless router, the short-distance wireless transceiver being in communication with the could server via the wireless router.

6. The wireless voice-controlled system according to claim 3, wherein the first wireless transmitting-receiving unit further comprises a long-distance wireless transceiver and a short-distance wireless transceiver, the long-distance wireless transceiver is in communication with the cloud server, and the short-distance wireless transceiver is in wireless communication with the second wireless transmitting-receiving unit.

7. The wireless voice-controlled system according to claim 1, further comprising a voice translator being in wireless communication with the first wireless transmitting-receiving unit and wirelessly receiving the audio signal, the voice translator converting the audio signal into the text signal and wirelessly transmitting the text signal back to the first wireless transmitting-receiving unit.

8. The wireless voice-controlled system according to claim 7, wherein the first wireless transmitting-receiving unit comprises a short-distance wireless transceiver, the short-distance wireless transceiver is in wireless communication with the voice translator and the second wireless transmitting-receiving unit, respectively.

9. The wireless voice-controlled system according to claim 1, wherein the wearable voice transmitting-receiving device further comprises a first memory module storing an instruction correspondence table, the first processor checks the instruction correspondence table to select the at least one control instruction corresponding to the text signal.

10. The wireless voice-controlled system according to claim 9, wherein the controlled electrical device further comprises identification information, the first memory module further stores an identification correspondence table, the first processor further checks the identification correspondence table to select an identification message corresponding to the text signal, the control signal further comprises the identification message, the second processor executes the at least one control instruction when the second processor checks the identification information matches with the identification message.

11. The wireless voice-controlled system according to claim 10, wherein the controlled electrical device further comprises a plurality of relay switches, each of the relay switches further comprises a serial number, the first memory module further stores a serial-number correspondence table, the first processor further checks the serial-number correspondence table to select a serial-number identification message corresponding to the text signal, the control signal further comprises the serial-number identification message, the second processor executes the at least one control instruction when the second processor checks the serial number matches with the serial-number identification message.

12. The wireless voice-controlled system according to claim 1, wherein the second processor further generates a feedback signal in response to the control signal and wirelessly transmits the feedback signal to the first wireless transmitting-receiving unit via the second wireless transmitting-receiving unit, the feedback signal is a feedback audio signal, a response instruction, or a combination thereof, the wearable voice transmitting-receiving device further comprises a response unit to perform a response operation for the feedback signal.

13. The wireless voice-controlled system according to claim 1, wherein the wearable voice transmitting-receiving device is a wearable headset microphone device, a wearable microphone, or a wearable wireless microphone, the controlled electrical device is a smart receptacle, a smart audio equipment, a smart air-conditioner, or a smart extension phone.

14. A wearable voice transmitting-receiving device, comprising:
a voice receiving unit receiving a voice instruction and converting the voice instruction into an audio signal;
a wireless transmitting-receiving unit electrically connected to the voice receiving unit and receiving the audio signal, the wireless transmitting-receiving unit wirelessly transmitting the audio signal out and wirelessly receiving a text signal, wherein the text signal comprises a text message corresponding to the audio signal; and
a processor electrically connected to the wireless transmitting-receiving unit and receiving the text signal, the processor generating a control signal according to the text signal and transmitting the control signal back to the wireless transmitting-receiving unit, the control signal comprising at least one control instruction, the wireless transmitting-receiving unit wirelessly transmitting the control signal out.

15. The wearable voice transmitting-receiving device according to claim 14, wherein the audio signal is uncompressed audio code or compressed audio code.

16. The wearable voice transmitting-receiving device according to claim 14, further comprising a memory module storing an instruction correspondence table, the processor checking the instruction correspondence table to select the at least one control instruction corresponding to the text signal.

17. The wearable voice transmitting-receiving device according to claim 16, wherein the memory module further stores an identification correspondence table, the processor further checks the identification correspondence table to select an identification message corresponding to the text signal, the control signal further comprises the identification message.
